(19) United States
(12) Patent Application Publication
(10) Pub. No.: US 2015/0339872 A1
(43) Pub. Date: Nov. 26, 2015

(54) System for securing packages

(71) Applicant: servicesite GmbH, Essen (DE)

(72) Inventor: Roland Waubert de Puiseau, Essen (DE)

(73) Assignee: servicesite GmbH, Essen (DE)

(21) Appl. No.: 14/719,777

(22) Filed: May 22, 2015

(30) Foreign Application Priority Data
May 23, 2014 (DE) 10 2014 007 507.9
Aug. 14, 2014 (DE) 10 2014 011 950.5
Aug. 15, 2014 (DE) 10 2014 012 030.9

(51) Int. Cl. G07C 9/00

(52) U.S. Cl. CPC G07C 9/00166

(57) ABSTRACT

System for securing packages against unauthorized access, preferably for receiving and/or shipping packages, with several securing devices for securing a package and with a central device, which is designed to receive a reservation signal and on the basis of the reservation signal to select one of the securing devices, hereinafter referred to as a selected securing device, and to generate and to emit a booking signal and/or a reservation confirmation signal, whereby the selected securing device can be controlled by verification with the booking signal and/or the reservation confirmation signal in such a way that the package can be secured in or released from the selected securing device.

### BACKGROUND OF THE INVENTION

1. Field of the Invention

This invention relates to a system and a method as well as a device for securing objects, in particular packages, against unauthorized access, preferably for receiving and/or shipping packages.

2. Description of Related Art

This invention relates in particular to the receiving and/or shipping of packages, such as packets, parcels, food shipments, or other objects. This invention can, however, also be used in general for securing packages or other objects against unauthorized access and/or removal.

In terms of this invention, the term “package” is therefore understood in preferably broad terms and encompasses objects that are in particular generally portable or separately shippable/movable. To ensure better understanding, this invention is explained below but always based on the especially preferred example of a shipping or receiving of packages.

This invention can also be used in principle in fields other than in the field of shipping or receiving packages, for example in connection with mailboxes, P.O. boxes, or pigeon-holes for goods or other objects, or else locker systems or other devices, which do not necessarily have to be provided for receiving and/or shipping packages.

During shipping, in particular the delivery, of packages, it may happen that the recipient or addressee of the package cannot receive or accept the package, for example because of absence. This results in the recipient having to pick up the package at a location other than the original destination. In such a case, the actual delivery of the package is consequently carried out behind schedule and/or with an additional expense for the recipient. Moreover, additional costs on the part of the delivery service provider are produced in the case of a failed attempt at delivery.

In principle, securing devices, such as mail-receiving containers, for accepting, securing and/or providing packages, are known. Such securing devices are in particular locker-type designs, in which packages can be stored and picked up at a later time. Such mail-receiving containers have a locked door or flap, which opens after a pick-up voucher is read in, thus making it possible for the stored package to be accepted or received.

Devices with a number of securing devices or mail-receiving containers or flaps that are now common are not, unlike mailboxes, assigned to specific residential units but rather are kept available centrally. They have the drawback that a recipient must first register for such a device for pick-up and also cannot accept a mailing at his place of residence. It is also necessary to indicate the address of the device instead of the residential address. The user must thus already know in advance where a package is to be delivered. In this case, it is to be taken into consideration that the distance to the closest system may be several hundred meters, which is disadvantageous due to transportation costs/expenditure in particular when receiving heavy or bulky mailings.

In one alternative, individual securing devices or mail-receiving containers are assigned to physical addresses, arranged in particular, i.e., in each case at a house or in front of a house. In principle, with such systems that are tied to persons or places of residence, it is possible to avoid having a recipient of a mailing have to travel longer distances to a securing device or a mail-receiving container. In principle, this invention relates to such decentralized solutions with securing devices or mail-receiving containers that are structurally separate and assigned to residential units such as apartments or houses. Such solutions are equipped with only one or a few mail-receiving containers, which is why routine alternative deliveries or pick-ups at a branch are nevertheless necessary in the case of occupancy of such a mail-receiving container. Moreover, previously-known decentralized systems have always been provider-specific in order to avoid access to packages by foreign companies.

### SUMMARY OF THE INVENTION

Therefore, the object of this invention is to provide a system, a method, and a device for securing packages against unauthorized access, preferably for receiving and/or shipping packages, by which a delivery close to a place of residence is made possible, an alternative delivery, new delivery or branch delivery is avoided, and/or the load on or efficiency of the systems tied to the residential unit for receiving and/or shipping packages can be improved.

This object is achieved by a system, a method and a central device as described herein.

A first aspect of this invention relates to a system for securing packages against unauthorized access, preferably for receiving and/or shipping packages.

In terms of this invention, packages are preferably packets, mailings, parcels, (large) letters, food shipments or other objects, which are transported, picked up and/or delivered by postal service providers, parcel services, logistics firms and/or an authorized individual. Moreover, reference is made to the definition mentioned in the introduction.

The system has several securing devices for securing a package in each case. Advantageously, the combination of several securing devices in the system makes possible a centralized management and control of the securing devices, which makes possible a significantly more efficient use, for example, even of adjacent securing devices.

In terms of this invention, a securing device is preferably a device that is designed in particular to protect or secure a package against removal and/or unauthorized sampling, theft, damage and/or vandalism. Preferably, the securing device is a mail-receiving device or a mail-receiving container, such as a mailbox, parcel box, or another device with a securing mechanism for securing a package, such as a flap, a lock, a latch, a catch, a door, or the like.

In terms of this invention, a securing device is especially preferably a container that is in particular like a box, chest, or compartment.

Preferably, the securing device has an opening for depositing and/or for removing the package.

The opening for depositing and/or for removing the package preferably has a clear width, which is greater than 50 cm, preferably greater than 60 cm, in particular greater than 70 cm, and/or less than 150 cm, preferably less than 100 cm, and in particular less than 80 cm.

The opening is preferably designed in a closable manner for securing the package. Especially preferably, the opening of the securing device can be closed by means of a closing device, such as a door or flap, which in particular can be locked or unlocked, and can be controlled automatically and/or electronically for securing or releasing.

The package can preferably be secured or released with the securing device in such a way that the opening is made available, the closing device is released, or access to the package or a securing area for securing the package is made available in some other way.

Preferably, a shipped item and/or package is secured by means of the securing device by depositing, inserting and/or sliding it into the securing device and/or closing or locking the securing device. Especially preferably, a shipped item or package that is secured by means of the securing device is inaccessible and/or immovable relative to the securing device.

Preferably, a shipped item is released by means of the securing device by unlocking and/or opening up the securing device. Especially preferably, a released shipped item can be extracted or removed from the securing device.

In particular, the securing device has a compartment, whereby the package can be secured or released by opening the compartment, depositing the package, and then closing the compartment. Here, however, in principle other solutions are also possible.

In an especially preferred embodiment, the securing device has a door or flap that is spring-loaded in the opening direction in such a way that the door or flap opens automatically in the case of an (automatic) unlocking. After depositing or removing the package, the door or flap can then be closed against the spring force, whereby preferably an (automatic) locking is carried out.

The securing device can bound a volume by walls or make it inaccessible in some other way, preferably in such a way that the package for securing can be placed in the volume and for releasing can be removed again from the volume.

The securing device preferably has a volume that is more than 15 l, preferably more than 20 l, in particular more than 25 l, and/or less than 150 l, preferably less than 120 l, and in particular less than 100 l.

The system also has a central device. The central device is preferably a data processor, a computer, a server, or it has a data-link device, a computer or a server. Here, however, other solutions are also possible. For example, the central device can also be a virtual unit of computers and/or be produced by so-called cloud-computing. Preferably, the central device is arranged physically separated and/or at some distance from the securing device. In particular, the central device and the securing device are arranged at various sites.

The central device is designed to receive a reservation signal. For this purpose, the central device preferably has a user interface. As an alternative or in addition, the central device has at least one receiver or transceiver for receiving the reservation signal. The receiver or transceiver can be part of the user interface or vice versa. Here, however, other solutions are also possible.

In terms of this invention, a signal is preferably a means for information transmission, a (modulated) wave, in particular in a conductor, a bit sequence, a packet in terms of information technology or the like. In terms of this invention, a signal can preferably be transmitted via a transmission medium or by means of a data connection. Preferably, information is assigned to a signal or contained in the signal, which can be transmitted by means of the signal.

The reservation signal is preferably a signal that has information for a reservation or booking of a securing device and/or with a package that is to be secured or released.

On the basis of the reservation signal, the central device is designed to select one of the securing devices, hereinafter referred to as a selected securing device.

The selected securing device can be or is assigned to the reservation signal or a part thereof, preferably by the central device. Therefore, as an alternative or in addition, the selected securing device is also referred to as an assigned securing device. The terms “selected securing device” and “assigned securing device” can be used synonymously or are preferably interchangeable.

Preferably, the reservation signal is received by the central device and further processed. The reservation signal can be analyzed by the central device. As a result, or because of the result of this analysis, the securing device can then be selected.

The central device is preferably also designed or set up to generate and to emit a booking signal and/or a reservation confirmation signal.

In terms of this invention, a booking signal is preferably a signal that has information for control and/or for the operation and/or for verification by means of one or more securing devices.

The central device is preferably designed to control the selected securing device with the booking signal and/or the reservation confirmation signal so that the package with the selected securing device can be secured or released.

It is preferred that a booking signal that is transmitted from the central device to the selected securing device is used for a verification process, with which the securing device is controlled, in particular opened.

As an alternative or in addition, the reservation confirmation signal is emitted, read in from the selected securing device, and used for a verification process, with which the securing device is controlled, in particular opened.

Especially preferably, the verification is carried out by means of the booking signal that is transmitted to the selected securing device and the reservation signal that is read in by the securing device, by which the selected securing device can be controlled, or the package can be secured or released with the selected securing device.

With the system according to the proposal, the function of the respective securing device can advantageously be adapted dynamically. In particular, it is possible with the system according to the proposal, with regard to different users, in particular parcel services, recipients and/or shippers, to make possible a securing of packages with the same securing device at different times.

The invention according to the proposal also makes possible the determination and reserving of suitable securing devices/mail-receiving containers in the run-up to a delivery. Consequently, new deliveries or alternative deliveries are avoided. In this way, the shipping or receiving of packages can be achieved in a manner that is significantly more efficient, more economical, resource-saving, time-saving and predictable. In particular, the average energy consumption for a delivery is reduced by the avoidance of alternative deliveries or new deliveries, for example by a lower fuel consumption of the delivery vehicles.

The system according to the proposal also offers advantages by an efficient delivery or pick-up of packages near the place of residence. With the system according to the proposal, securing devices can be assigned directly to residential units such as apartments, houses or households or attached to the latter, by which the expense for the acceptance or pick-up or hand-over or release of the package is reduced. In this case, in individual cases where there are too few securing devices or they are not of the proper size, the system according to the proposal offers the possibility of determining and/or using an alternative securing system that is as close by as possible, for example a mail-receiving container of the neighbors. Preferably, for this purpose, a securing system can be made available or restricted for a use by a specific group of third parties, for example direct neighbors or neighbors within a specific circumference. In this way, an expensive pick-up at a branch or a central mail-receiving container system is unnecessary at a greater distance.

As a result, with the system according to the proposal, the availability of securing devices, in particular securing systems that are assigned to residential units that are near the place of residence or in the immediate vicinity, is considerably improved, even if per household, residential unit, apartment, house, or the like, only one or a small number of securing systems are provided.

Preferably, the securing devices in each case have a transceiver for receiving the booking signal from the central device. The central device is preferably designed to transmit the booking signal over a data connection to the selected securing device and to control the selected securing device with the transmitted booking signal. Because of the transmitting of the booking signal, in particular the authorization to secure or to release a package with the selected securing device can be adapted dynamically, by which the same (selected) securing device can be used by different groups of people.

The system preferably has one or more reservation device(s) for generating and/or transmitting the reservation signal to the central device. The reservation device can be assigned to a parcel service, commercial enterprise, or logistics firm. In particular, the reservation device can have an interface to a logistics system. It is preferred that the reservation device generate the reservation signal with or from information of a package that is to be secured or to be secured, preferably in the form of one or more parameters or a set of parameters. The information of a package that is to be secured includes in particular a target location, physical properties of the package and/or a preferred length of time of the securing/delivery and/or the releasing/pick-up.

Preferably, the system has at least two, preferably more than two or more than three, in particular more than five or ten, reservation devices. This makes possible the use by different individuals or institutions. The system and/or the central device is preferably designed to synchronize the reservation devices with one another.

The physical properties preferably comprise a dimension, a weight, a perishability, durability, requirement for refrigeration, insulation property, and/or a durability, stability, and/or perishability based on a temperature and/or storage time, in particular of the package or of one or more objects assigned to the package or comprised by the package.

The reservation device is assigned and/or the reservation devices are in each case preferably assigned to parcel services, commercial enterprises or logistics firms. The central device is preferably designed to process reservation signals received by the reservation devices sequentially and/or according to priorities according to the first-in first-out principle, in order to select securing devices, in particular in such a way that a double booking or a selection of the same securing device for different packages is prevented.

Preferably, the reservation signal has a location query indicator for identifying a target location for securing the package. The central device is designed to determine distances in each case between the target location and the respective site of the securing devices and to select the securing device based on a comparison of the distances. The location query indicator advantageously makes it possible with the central device to determine, to select and/or to prioritize the securing devices that have as short as possible a distance from the target location.

As an alternative or in addition, the reservation signal has a package parameter that corresponds to physical properties of the package that is to be secured. The central device is preferably designed to check the securing devices for suitability for securing a package with the physical properties and to select the securing device based on the suitability. In this way, advantageously, a selection of a securing device that is unsuitable for the particular package is avoided.

As an alternative or in addition, the reservation signal has a time query indicator for identifying a time, a date, and/or a length of time, preferably at which the package is to be secured with one of the securing devices. Preferably, the central device is designed to compare the time identified by the time query indicator, the date identified by the time query indicator and/or the length of time identified by the time query indicator with an availability of the securing devices and to select the securing device based on the result of the comparison. In this way, an optimal loading of the respective securing device can be achieved, and a collision in the use of the respective securing device can be avoided.

Preferably, the central device is designed to generate the booking signal for controlling the selected securing device and/or to transmit it to the selected securing device.

The booking signal preferably has a securing verification means for verification of a user who is authorized to secure the package, whereby the respective securing device is designed to make possible a securing of the package only after verification with the securing verification means. Advantageously, in this way, it can be achieved that only suitable packages with corresponding authorization or prior reservation with the central device can be secured with the selected securing device. Consequently, double bookings, overlapping or other collisions are effectively prevented.

As an alternative or in addition, the booking signal has a releasing verification means for verification of a user who is authorized to release the package, whereby the respective securing device is designed to make possible a releasing of the package only after verification with the releasing verification means. In this way, advantageously, it can be ensured that a release is made possible only with the corresponding authorization and/or after securing; in particular, a package thus is not matched and purloined by an unauthorized third party.

As an alternative or in addition, the booking signal has a time reservation indicator for identifying a length of time in which the package is to be secured with the securing system, whereby the respective securing device is designed to make possible a securing and/or releasing of the package only during the length of time identified by the time reservation indicator. This makes it possible to reuse the respective securing device multiple times for different packages and/or different entities that are picking up and/or shipping while avoiding double occupancies.

The central device is preferably designed to generate and/or to emit a reservation confirmation signal. The reservation confirmation signal is preferably a signal that has information relative to the selected securing device and/or relative to its securing and/or releasing. The reservation confirmation signal has in particular information relative to the site of the selected securing device and a length of time of its reservation.

The central device is preferably designed to transmit the reservation confirmation signal to the reservation device or to a receiving device that is assigned to the reservation device. The reservation device can thus transmit the reservation signal to the central device, and after selection of the securing device as a response from the central device, the reservation device can receive the reservation confirmation signal with information relative to the selected securing device.

Preferably, the reservation confirmation signal has a time confirmation indicator for identifying a date, a time, and/or a length of time, relative to or via which the package is to be secured with the assigned securing system. The time confirmation indicator can match the time reservation indicator or correspond thereto. In particular, the central device assigns a reservation signal to the selected securing device over a specific length of time, which preferably is oriented to the length of time identified by the time reservation indicator, in particular begins during the length of time identified by the time reservation indicator, or comprises the latter. In this way, prompt securing or releasing of the package with the assigned securing device or prompt pick-up or delivery can be achieved advantageously.

As an alternative or in addition, the reservation confirmation signal has a location confirmation indicator for identifying a site of the selected securing device for securing the package. Preferably, a distance from the target location relative to the respective securing device is determined, by which a securing device with the smallest possible distance to the target location can be selected. The effect of this is that the site of the assigned or selected securing device can deviate from the target location. It is therefore preferred that the reservation confirmation signal has the site of the selected securing device or an identifier corresponding thereto.

As an alternative or in addition, the reservation confirmation signal has a securing identifier for identifying a user who is authorized to secure the package, whereby the selected securing device is designed to make possible a securing of the package only after verification with the securing identifier.

As an alternative or in addition, the reservation confirmation signal has a releasing identifier for identifying a user authorized to release the package, whereby the selected securing device is designed to make possible a releasing of the package only after verification with the securing verification means.

The securing identifier or releasing identifier and/or the securing verification means or releasing verification means is preferably a one-time identification, random sequence, bit string, a key or another verification means, which preferably is designed to make a possible verification with the securing device. The verification with the securing identifier and/or the securing verification means can make possible or initiate a securing process with the releasing identifier and/or the releasing verification means or a releasing with the selected securing device.

In terms of this invention, an identification device, also referred to as a receiving device, is preferably designed to receive and/or to buffer the securing identifier and/or the releasing identifier from the central device.

As an alternative or in addition, the identification device is preferably designed, in terms of this invention, to send the securing identifier and/or the releasing identifier, preferably in a wireless manner, preferably to the verification device.

The identification device and/or the booking device is preferably a mobile, active or passive device. The identification device and/or the booking device is preferably or preferably has: one or more smartphones, computer, NFC controller, smart cards, transponder, terminals, tablets, PCs, NFC devices, RFID devices, displays, infrared-, radio-, electrical-, magnetic- and/or electromagnetic transmitters, receivers, transceivers and/or transponders, pocket devices, mobile- and/or network-independent or wireless devices, etc.

The identification device is preferably designed to transmit the securing identifier and/or the releasing identifier, in particular exclusively, in the immediate vicinity or visual range of the verification device, to the latter in order to produce a securing or releasing with—or an opening of—the selected securing device.

The system according to the proposal preferably has several identification devices, preferably a first identification device for securing the package and/or having the securing identifier and a different second identification device for releasing the package and/or having the releasing identifier.

Preferably, the securing identifier and/or the releasing identifier can be retrieved by the verification device from the identification device and/or can be transmitted to the verification device, in particular by which the securing device opens or the package can be secured and/or released in some other way.

The securing identifier or releasing identifier and/or the securing verification means or releasing verification means is preferably generated and/or transmitted by the central device. The securing identifier or releasing identifier and/or the securing verification means or releasing verification means is/are preferably generated with use of the reservation signal, corresponds/correspond to the reservation signal, or corresponds/correspond to a part of the reservation signal. Here, however, other solutions are also conceivable.

For example, the securing identifier or releasing identifier can be a device assigned to the central device and/or the booking device or a device assigned to the booking device, of an already known, filed or stored identifier, which does not necessarily have to be transmitted by the central device to the selected securing device. In this case, it is preferred that an identification of the package or of a user of the system according to the proposal, in particular a parcel service employee, be used as a securing identifier and/or releasing identifier.

The securing identifier and the securing verification means are preferably different and/or can be transmitted with different media to the selected securing device. The same is true for the releasing identifier and the releasing verification means.

In one variant, it is preferred that a verification for securing and/or releasing with the securing device is carried out with use of a known or predetermined securing identifier or releasing identifier. For example, the securing identifier or releasing identifier is an identification means such as a smart card, a transponder, a tag, or another storage device that can be read in or read out via the respective securing device, which storage device has the securing identifier or releasing identifier. In this variant, it is preferred that the central device control the selected securing device, in particular with the booking signal, in such a way that a securing of the package is made possible with the securing identifier or a releasing of the package is made possible with the releasing identifier. For this purpose, it is preferred that the booking signal have a securing verification means that corresponds to the securing identifier and/or a releasing verification means that corresponds to the releasing identifier. This variant offers advantages with respect to a less expensive and uncomplicated verification, since for one or more verifications, the securing identifier or releasing identifier does not have to be updated.

In another variant, it is preferred that the securing verification means and/or releasing verification means is/are already predetermined and/or is/are stored or filed in the respective securing device and/or in the central device, in particular as lists, as elements that can be used only once, etc. In this case, it is preferred that with the reservation confirmation signal, a securing identifier that corresponds to the securing verification means and/or a releasing identifier that corresponds to the releasing verification means is/are produced and/or emitted and/or transmitted, preferably by the central device.

For example, a specific sequence of transaction numbers or other transaction identifiers can be assigned to a specific securing device. These transaction numbers or transaction identifiers or securing identifiers or releasing identifiers that correspond thereto are preferably filed, stored in the central device and/or filed in a database or in a table. Preferably, the securing identifiers and/or the releasing identifiers are assigned to the transaction numbers or transaction identifiers or the securing verification means or releasing verification means, in particular in a table. When receiving a reservation signal, a securing device can be selected, a securing identifier or releasing identifier that corresponds to the selected securing device can be determined, selected or read out, and the corresponding securing identifier or releasing identifier can then preferably be emitted or transmitted with the—or as a—reservation confirmation signal, in particular by the central device.

This variant offers advantages in that no data connection, or at least no continuous data connection, is absolutely necessary between the respective securing device and the central device. Consequently, undeveloped areas can also be equipped with securing devices by data connection. Since, moreover, energy can be saved when the data connection is not required or at least not continuously required, this variant also has advantages relative to securing devices that are battery-operated, rechargeable-battery-operated or operated by regenerative energies, for example by means of photovoltaics or wind energy or with use of energy-harvesting technologies.

Especially preferred is a variant in which the securing identifier and the securing verification means are determined or generated corresponding to one another, for example as a key pair or the like, preferably generated in each case on a random basis. As an alternative or in addition, the releasing identifier and the releasing verification means can be determined or generated corresponding to one another, for example as a key pair or the like. In this case, it is preferred that the securing identifier and/or releasing identifier is/are emitted and/or transmitted, and the securing verification means as well as the releasing verification means are transmitted to the selected securing device, preferably by the central device. This variant is especially preferred, since advantageously, it comes with no predetermined or previously stored or filed data, thus meaning that the system according to the proposal is especially robust with respect to compromises.

The variants above can be produced as an alternative or cumulatively. In particular, a combination of several of the cited variants in the same system is also possible. For example, the variant with the key pair and securing devices that cannot be connected or cannot be connected permanently to the central device for the data connection—the variant in which the securing verification means and/or releasing verification means are already predetermined—can be used for those securing devices that have a data connection with the central device or can be connected to the central device by data connection. In this way, the use of the system advantageously with respect to the verification with the securing identifier and/or the releasing identifier is the same for all securing devices. This can also form an independent aspect of this invention. However, other combinations of variants are also possible and advantageous.

Preferably, the central device is designed to generate a first reservation confirmation signal with the securing identifier and without the releasing identifier and a second reservation confirmation signal, different from the first, with the releasing identifier and without the securing identifier, and, preferably, to send the first and the second reservation confirmation signals to different identification devices. In this way, a securing and releasing by different users is made possible.

It is also preferred that the central device have a securing device database, in which relative to the securing devices, in each case securing device parameters corresponding to properties of the respective securing device are filed, in particular corresponding to properties relative to a site and/or a capacity and/or an occupancy and/or an access authorization of the respective securing device. It has been shown that when querying information from a plurality of securing devices, the selection of the suitable securing device can be time-consuming. Advantageously, the securing device database makes possible a significantly faster and more efficient selection of the securing device.

The central device is preferably designed to receive a securing device parameter that corresponds to a property of a securing device and/or to retrieve from the securing device(s) and/or to file in a/the securing device database preferably at least one securing device parameter that corresponds to a sensor signal of an availability sensor of the securing device.

The securing device(s) can have a sensor, in particular an interior surveillance system. In this way, it can be noted whether a package is currently secured by the securing device or not. If it is noted with the sensor that currently no package is secured with the securing device, it is preferably signaled that the securing device is available. As an alternative or in addition, it is signaled and/or filed, stored, or transmitted as a securing device parameter that the securing device is not available when it is currently stored in the package with the securing device. The securing device parameter can correspondingly represent an availability. As an alternative or in addition, the securing device parameter can also represent an occupancy or non-availability when a securing is imminent.

In one aspect of this invention, it is preferred that the securing device accept the securing identification means a second or another time after a one-time use if it is noted with the sensor or in some other way that with the one-time use, no package has been secured.

As an alternative or in addition, it is preferred that the securing device not accept the securing identification means, when it is noted with the sensor or in some other way that the securing device is still occupied or currently secures a package. In this case, an unauthorized access to a package can be avoided.

It is especially preferred that the securing device database have values or properties of the respective securing device as securing device parameters, in particular volumes, widths, lengths, heights, and/or load-bearing capacity relative to the weight of a package that is to be secured.

As an alternative or in addition, securing device parameters, which can be filed in the securing device database, are or form a cooling or tempering suitability and/or an insulation value relative to thermal insulation.

It is preferred that the securing device database can be updated relative to the variable properties of the respective securing device. Variable properties of the respective securing device are in particular the occupancy or the status whether a package with the particular securing device is currently secured or not, or whether a malfunction or another function is present or is active. Preferably, variable properties are routinely, continuously, or at intervals updated in a verification process with the securing identifier and/or with the releasing identifier or by the latter and/or at regular intervals, preferably automatically. Preferably, an identification, a transmission to and/or a retrieval by the central device of one or more variable properties of the respective securing device is carried out after a waiting period elapses, for example a minute, after a verification and/or upon conclusion or after concluding a securing or releasing by the securing device. In this way, the amount of data to be transmitted by the respective securing device and the associated energy consumption can be minimized. Furthermore, in this way, the processing power that is necessary in the central device is reduced.

The package parameter preferably represents properties of the package that is to be secured. In particular, the package parameter represents a dimension, a length, a width, a height, a volume, a weight, perishability, stability, storage life, requirement for refrigeration, an insulation value relative to thermal insulation and/or a hazardous material marking of the package or the goods to be secured or the object to be secured.

The central device is preferably designed to compare the package parameter to the securing device parameters, preferably the physical properties of the package, represented by the package parameter, with the capacity of the securing device represented by the securing device parameter. In this way, it can advantageously be determined whether a package is physically compatible with a certain one of the securing devices. Preferably, physically incompatible securing devices are then discarded and/or securing devices that are in principle physically compatible are selected, marked, included in a list or provided in some other way for another selection process.

According to an aspect of this invention that can also be achieved independently, it is provided that the central device then checks the package parameter as to whether the latter represents a requirement for refrigeration, perishability, stability and/or storage life. If the package parameter has a piece of information or a value relative to the perishability, the stability, the storage life and/or the requirement for refrigeration, preferably those securing devices are discarded that are unsuitable for storage of the package, in particular, i.e., that have, according to checking with the securing device parameter, an insulation value that is too low or that is in some other way unsuitable relative to the thermal insulation and/or a deficient cooling or tempering suitability.

In another aspect of this invention that can also be achieved independently and that can also be combined with the previous aspect, the package parameter has information or values relative to perishability, stability and/or storage life, which preferably take into consideration time and/or temperature dependency.

Preferably, individual perishability, stability and/or storage life of the package that is to be secured is determined for one or more of the securing devices on the basis of the securing parameters that correspond to the respective securing device. In particular, a (worst-case) temperature or a (worst-case) temperature profile of the package that is to be secured is calculated, simulated or forecast when securing the package with the respective securing device, preferably with use of the securing device parameter.

Preferably, those securing devices that lead to a perishability, stability or storage life below a threshold value when securing the package that is to be secured would be discarded and/or those securing devices for which the perishability, stability and/or storage life of the package that is to be secured reaches or exceeds a threshold value or a minimum requirement are selected, marked, included in a list, or provided in some other way for another selection process.

Preferably, the central device is designed to compare the time query indicator to the securing device parameter, preferably wherein the availability of the respective securing device represented by the securing device parameter is compared to the time, date and/or length of time indentified by the time query indicator, preferably by the central device. In this way, it can advantageously be determined whether a certain one of the securing devices is available or already occupied at the time specified by the time query indicator.

According to one aspect of this invention, those securing devices are discarded that are not available and/or those securing devices are selected, marked, included in a list or provided in some other way for another selection process, which is available within the length of time identified by the time query indicator, on the date identified by the time query indicator or within the time identified by the time query indicator. As an alternative or in addition, it can be provided that (also) those securing devices that are selected, marked, included in a list or are provided in some other way for another selection process are those that deviate (slightly) under predetermined conditions, in particular slightly, from the length of time identified by the time query indicator, from the date identified by the time query indicator or from the time identified by the time query indicator. Here, it is especially preferred that the time reservation indicator is transmitted with the booking signal and/or the time confirmation indicator is transmitted with the reservation confirmation signal. In other cases, this is not necessarily required.

Preferably, the central device is designed to compare the location query indicator to the securing device parameter, preferably wherein a distance between the target location identified by the location query indicator and the respective site of the securing devices identified by the securing device parameter is determined. By comparison of the distances, such securing devices, which are located nearby, can be prioritized. The distances are especially preferably used in order to sort or to prioritize the removal of the securing devices. Thus, below, the securing device can be selected that has the shortest distance or that is assigned the shortest distance, and, preferably, meets the other criteria relative to compatibility and availability.

As a whole, the central device is preferably designed to select the securing device that according to the result of the comparison of the package parameter to the securing device parameter is physically suitable for securing and/or according to the result of the comparison of the time query indicator to the securing device parameters is available, and/or according to the result of the comparison of the location query indicator to the securing device parameter has the shortest distance from the target location.

Especially preferably, in a first step, those securing devices are selected, included in a list, marked or preselected that are physically suitable and available for securing the package. As an alternative or in addition, those securing devices are deselected, discarded or marked that are either physically unsuitable for securing and/or are not available, at least in the length of time corresponding to the time query indicator. The securing devices, which are physically suitable and available for securing the package, are then examined in a second step preferably relative to their distance to the target location. Preferably, the securing device is selected that is physically suitable and available for securing the package and at the same time has the smallest distance to the target location.

The central device preferably has the securing device database in which preferably securing device parameters are filed, stored and/or preserved. According to one aspect of this invention, the securing device database is of a hierarchical and/or aggregated design. This makes possible an accelerated navigation through the database and selection in principle of the securing devices in question.

Preferably, before or during the selection process, only those securing devices that lie in a specific area, for example, a postal code area, are taken into consideration. For this purpose, pre-selection of securing devices or data sets corresponding thereto can be carried out from the securing device database. A database extract is preferably formed by this pre-selection. The database extract preferably has a partial amount of the total available securing devices or the data sets corresponding thereto. Preferably, the selection of the securing device, in particular by the central device, is carried out on such a selection, such a database extract or such a partial amount of the total available securing devices or the data sets corresponding thereto. The pre-selection is preferably done before the first step and/or based on the location query indicator or the target location that is identified in this way.

Another also independently achievable aspect of this invention relates to a method for securing packages against unauthorized access, preferably for receiving and/or shipping packages, with several securing devices for securing a package and with a central device that is designed to receive a reservation signal, wherein one of the securing devices is selected on the basis of the reservation signal, hereinafter referred to as the selected securing device, and a booking signal and/or a reservation confirmation signal is/are generated and emitted by the central device, wherein the selected securing device secures or releases the package with the selected securing device by verification with the booking signal and/or the reservation signal. In general, aspects described in connection with the system, the central device, the reservation device and/or the securing device(s) also form method features of the method according to the proposal, in particular when the respective device is designed to perform a method step or the like.

Another also independently achievable aspect of this invention relates to a central device for a system according to the proposal for securing packages against unauthorized access, preferably for receiving and/or shipping packages. In this case, it is especially preferred that the central device have a user interface for a data connection with several securing devices for securing a package, wherein the central device is designed to receive a reservation signal and on the basis of the reservation signal to select one of the securing devices, hereinafter referred to as a selected securing device, and wherein the central device is designed to generate and/or to emit a booking signal and/or a reservation confirmation signal, wherein the booking signal and/or reservation confirmation signal is designed so that the package can be secured or released with the selected securing device during verification with the booking signal and/or the reservation signal.

Additional, also independently achievable, aspects of this invention relate to the use of the central device for shipping and/or receiving packages or the use of several securing devices, which are administered centrally, preferably by the central device.

Additional aspects, advantages and properties of this invention result from the claims and from the following description of a preferred embodiment based on the drawing. Here:

### BRIEF DESCRIPTION OF THE DRAWINGS

FIG. 1 shows a system according to the invention;

FIG. 2 shows securing devices that are assigned to various sites;

FIG. 3 shows a securing device according to the invention;

FIG. 4 shows a simplified, diagrammatic view of the system according to the invention when securing the package; and

FIG. 5 shows a simplified, diagrammatic view of the system according to the invention when releasing the package.

### DETAILED DESCRIPTION OF THE INVENTION

In the figures, the same reference numbers are used for the same or similar parts, wherein the same or similar properties and advantages can be achieved, even if a description is not repeated.

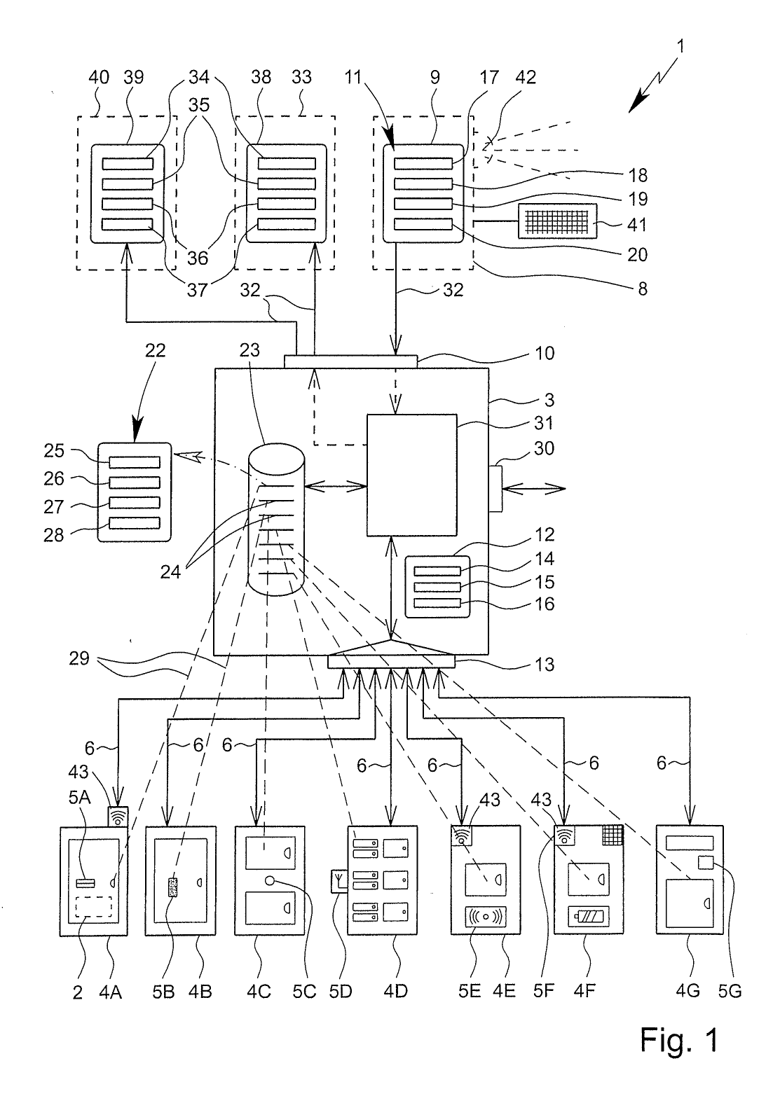

FIG. 1 shows a system 1 according to the invention for securing objects, in particular packages 2, against unauthorized access. The system is preferably designed for receiving and/or shipping objects or packages 2.

The system 1 has a central device 3 for controlling several securing devices 4A to 4K for securing objects 2 against unauthorized access.

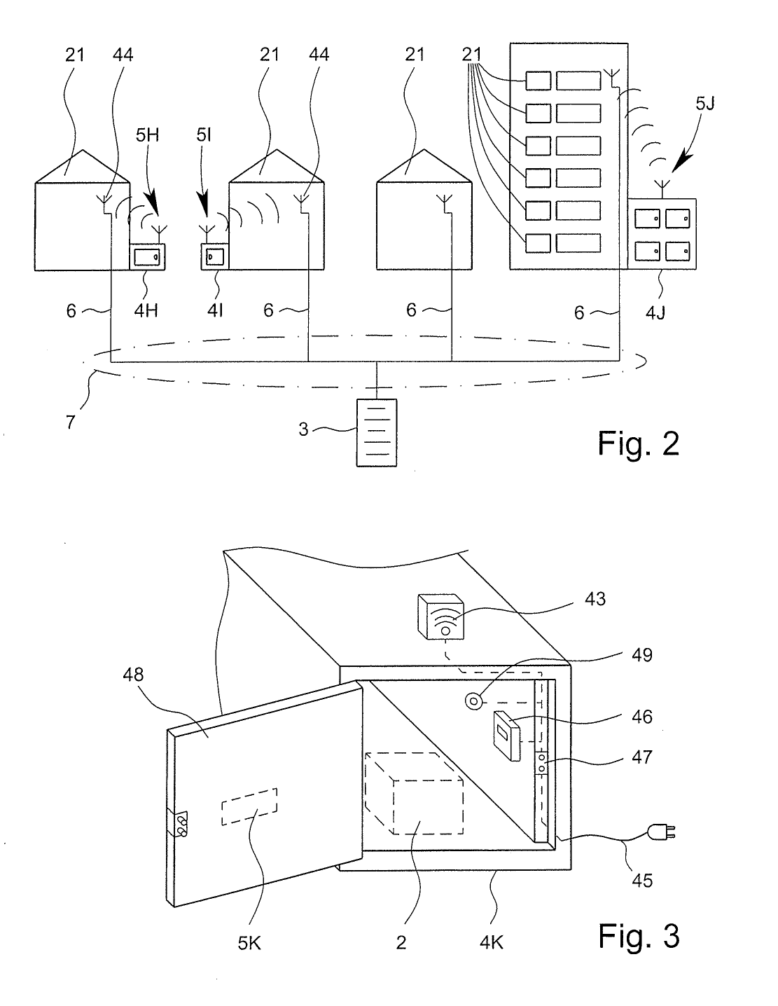

As depicted in FIG. 2 by way of example, the securing device 4A to 4K and the central device 3 are preferably produced structurally separately from one another and/or are arranged at various sites. Preferably, the securing devices 4A to 4K in each case are assigned to various residential units 6. Here, however, other solutions are also possible.

In each case, the securing devices 4A to 4K preferably have a verification device 5A to 5K for verification of the authorization for securing and/or releasing a package 2.

In each case, a verification device 5A to 5K is preferably electrically and/or mechanically connected to a corresponding securing device 4A to 4K. In this case, various verification devices 5A to 5K are possible.

Especially preferably, however, the securing devices 4A to 4K have the same or at least in each case a similar verification device 5A to 5K. In this case, this can be a reader 5A, in particular a smart card reader, a magnetic strip reader, a barcode reader, a QR code reader, or the like. As an alternative or in addition, this can be a keyboard or a pin pad 5B, an iris scanner or a camera 5C, a radio interface 5D, an NFC or a near field communication interface 5E, a WLAN interface 5F or another, especially preferably wireless, interface 5G to 5K.

In the illustrative example according to FIGS. 1 and 2, various verification devices 5A to 5K are assigned to the various securing devices 4A to 4K only for reasons of illustration of which only 4H, 5H and 4I, 5I are shown in FIG. 2 for simplicity. It is preferred, however, that within a system 1, all securing devices 4A to 4K have at least one similar verification device 5A to 5K, especially preferably a scanner for scanning a display and/or a near field communication interface for verification by means of near field technology.

The securing devices 4A to 4K preferably have in each case a data connection 6 to the central device 3. In the illustrative example according to FIG. 2, the data connection 6 or the data connections 6 has/have a network 7, in particular the Internet, or are formed for this purpose. Here, however, other solutions are also possible. In particular, the data connection 6 has a mobile radio link, a WLAN link, and/or a TCP/IP or Internet link.

The system 1 preferably also has a reservation device 8, with which a reservation signal 9 is generated and/or can be transmitted to the central device 3. The central device 3 preferably has a user interface 10 for receiving the reservation signal 9.

The reservation signal 9 is preferably a signal that has information for a reservation or booking of a securing device 4A to 4K and/or about a package 2 that is to be secured or released.

The reservation signal 9 preferably has reservation information 11 relative to an object 2 that is to be secured. On the basis of the reservation information 11, the central device 3 identifies a securing device 4A to 4K that is suitable for the object 2 that is to be secured. The identified securing device 4A to 4K is preferably selected by the central device 3 and/or assigned to the reservation signal 9 or parts thereof. The securing device 4A to 4K that is assigned to the latter or selected in some other way and/or the reservation signal 9 or parts thereof is hereinafter referred to as selected or assigned securing device 4A to 4K.

The central device 3 preferably controls the securing devices 4A to 4K as a function of the assignment. For this purpose, it is especially preferred that the central device 3 generate a booking signal 12 for controlling the assigned securing device 4A to 4K. With this booking signal 12, the central device 3 can control the selected or assigned securing device 4A to 4K in such a way that the object or the package 2 can be secured or released with the selected or assigned securing device 4A to 4K.

Preferably, the securing devices 4A to 4K in each case have a transceiver, in particular for receiving the booking signal 12 from the central device 3.

The booking signal 12 is preferably transmitted via a securing device interface 13 and/or the data connection(s) 6 to the assigned or selected securing device 4A to 4K.

The booking signal 12 preferably has a securing verification means 14, a releasing verification means 15, and/or a time reservation indicator 16.

The securing verification means 14 is preferably designed to verify a user who is authorized to secure the package 2. The releasing verification means 15 is preferably designed to verify a user who is authorized to release the package 2. The time reservation indicator 16 is preferably designed to identify a length of time in which the package 2 is to be secured with the securing system 4A to 4K.

In particular, the booking signal 12 is a data set or has a data set that controls the assigned or selected securing device 4A to 4K for securing and/or releasing the object or package 2 within an identified length of time.

The reservation signal 9 preferably has, in particular as reservation information 11, a package parameter 17 and/or an authorization identifier 18 and/or a time query indicator 19 and/or a location query indicator 20.

The package parameter 17 preferably corresponds to one or more physical properties of the package 2 that is to be secured. The package parameter 17 especially preferably has a length, width, height and/or a weight of the package 2 that is to be secured. In this way, it can be determined whether a securing device 4A to 4K in principle or physically is or is not suitable for securing the package 2.

The authorization identifier 18 is preferably designed for identifying an authorization of the securing and/or releasing of the package 2 that is to be secured. With the authorization identifier 18, a user who would like to secure an object or a package 2 with a securing device 4A to 4K can be identified, and/or the authorization for using a particular securing device 4A to 4K can be examined. The transmission of the authorization identifier 18 as part of the reservation signal 9 is not necessary, for example, when an authorized user has registered or applied prior to this with the central device 3.

The time query indicator 19 is preferably designed for identifying a date, a time, and/or a length of time, relative to which the object or the package 2 is to be secured with a securing device 4A to 4K.

The location query indicator 20 is preferably designed to identify a target location for the securing of the object or package 2. A target location 21 is especially preferably a physical address, a mailing address, a residential unit, overall position of a residential unit and/or (GPS) coordinates or has such. The location query indicator 20 preferably has, i.e., an address and/or coordinates or other positional information.

The central device 3 preferably has access to securing device parameters 22. The securing device parameters 22 preferably correspond to one or more properties of a securing device 4A to 4K. The central device 3 preferably has access to the securing device parameters 22 of all securing devices 4A to 4K of system 1.

The securing device parameters 22 preferably have a physical property, in particular length, width and/or height of a receiving volume, a load capacity relative to the weight of a package 2 that is to be secured, an availability or occupancy and/or a functionality of the respective securing device 4A to 4K or parameters corresponding thereto.

The securing device parameters 22 can be called up and/or received by the central device 3 if necessary and/or directly, in particular via data connections 6, from the respective securing device 4A to 4K. As an alternative or in addition, the securing device parameters 22 are filed or stored in a securing device database 23. Preferably, securing device parameters 22 are filed or stored by the central device in the securing device database 23.

The securing device database 23 is preferably part of the central device 3, assigned to the central device 3, or connected to the central device 3 by data connection. The securing device database 23 preferably has one or more data sets 24, in particular data sets 24 corresponding in each case to one of the securing devices 4A to 4K.

The data sets 24 preferably have parameters relative to physical properties 25, relative to availability properties 26, and/or relative to a functionality 27 and/or relative to an authorization 28 for use of the respective securing device 4A to 4K.

The data sets 24 of the securing device database 23 are preferably assigned in each case to a securing device 4A to 4K. In FIG. 1, assignments 29 are indicated by the dotted lines.

Preferably, the system 1 is designed to at least partially update the securing device parameters 22.

The parameter is especially preferably updated relative to an availability 26 on a regular basis, if necessary, and/or in an event-controlled manner, in particular when there is a change in availability.

As an alternative or in addition, the parameter relative to a functionality 27 and/or the parameter relative to an authorization 28 can also be updated. Relative to a functionality 27, the parameter is preferably then updated when the corresponding state of the respective securing device 4A to 4K changes. In particular, the parameter relative to a functionality 27 is automatically changed when an error occurs in a securing device 4A to 4K. In this case, it is preferred that the respective securing device transmits an error signal to the central device 3, whereupon the central device 3 correspondingly changes or matches the parameter relative to functionality 27.

The parameter relative to an authorization 28 can be configured or can be configurable by a holder or authorized party of the respective securing device 4A to 4K. In particular, the respective securing device 4A to 4K has an interface for configuration of an authorization on or for matching or changing the parameter relative to the authorization 28. As an alternative or in addition, the central device 3 can have a configuration interface 30, in particular a web interface, via which the securing device parameter 22, in particular the parameter relative to an authorization 28, can be configurable. Here, however, other solutions are also possible.

Preferably, the parameter relative to availability 26 is updated on a regular basis and/or automatically. For this purpose, the respective securing device 4A to 4K can communicate with the central device 3, in particular via the data connection 6, wherein availability information can be transmitted from the respective securing device 4A to 4K to the central device 3. The central device 3 can change the parameter relative to availability when, according to the availability information, the availability of the respective securing device 4A to 4K has changed.

The parameter relative to an availability 26 in particular represents a Boolean parameter, which represents the current status of the respective securing device 4A to 4K. For example, the parameter relative to an availability 26 is “1” when the assigned or selected securing device 4A to 4K does not currently have any packages secured, and it is “0” when the respective securing device 4A to 4K is currently occupied or already has a package 2 secured or vice versa. If necessary, the parameter can also be produced in another way relative to availability 26.

The parameter(s) relative to physical properties 25 of the respective securing device 4A to 4K is/are preferably constant. In one aspect of this invention, at least the parameters relative to physical properties 25 are not examined automatically, only manually, are examined automatically only at long intervals, or not examined at all, called up from the respective securing device 4A to 4K or sent to the central device 3. This offers the advantage of a reduced amount of data to be transmitted, which reduces energy demand and conserves system resources. In this case, it is to be taken into consideration that the system according to the invention preferably is operated with several hundred securing devices 4A to 4K, in particular with at least 1,000 securing devices 4A to 4K. Therefore, the central device 3 is preferably a computer center or a part thereof. The effort and the costs for producing the central device 3 are dependent upon effort. A differentiation relative to an updating between the individual securing device parameters 22 in the securing device database 23 thus leads directly to improved performance on the part of the central device 3 through a lower computational requirement.

The central device 3 is preferably designed on the basis of a requirement profile to select one of the securing devices 4A to 4K.

Preferably, the central device 3 has a selection module 31. The selection module 31 preferably has access to the securing device database 23 and/or to the securing device 4A to 4K. In particular, the selection module 31 is designed to retrieve one or more of the securing device parameters 22 from the database 23 and/or from one or more of the securing devices 4A to 4K.

When receiving the reservation signal 9, the reservation signal 9 or the reservation information 11 is preferably fed to the selection module 31. The selection module 31 is preferably designed to compare the reservation signal 9, the reservation information 11, in particular the package parameter 17 and/or the authorization identifier 18 and/or the time query indicator 19 and/or the location query indicator 20 to one or more of the securing device parameters 22. The comparison is preferably carried out between the reservation information 11 and the securing device parameter 22 that correspond to one another.

In a first step, it is determined, preferably by comparison of the authorization identifier 18 to the parameter relative to an authorization 28, whether—or relative to which of the securing devices 4A to 4K—a securing of a package 2 that corresponds to the reservation signal 9 is permissible.

Optionally, prior to or after this step, a group of securing devices 4A to 4K can be preselected, and the comparison to the preselected securing device 4A to 4K can be limited. Such a pre-selection is preferably carried out in terms of areas, relative to a region or relative to a circumference around the target location 21. In this way, the selection process can be advantageously simplified or accelerated.

In another step, it is examined—preferably with the parameter relative to functionality 27—whether the respective securing device 4A to 4K can be used. This step can also be carried out in advance or at another location.

In another step, the time query indicator 19 is compared to an availability of the respective securing device 4A to 4K. For this purpose, the respective data set 24 or the parameter relative to availability 26 can have a calendar or another piece of information relative to an expiration of time of the availability of the respective securing device 4A to 4K. Preferably, it is determined by a comparison of the time query indicator 19 to the parameter relative to availability 26 whether an availability of the respective securing device 4A to 4K is present in the length of time determined by the time query indicator 19.

Preferably, those (preselected) securing devices 4A to 4K are selected, marked or included in a list, which are both available and functional and have an authorization and physical properties that make possible a securing of the package 2.

In another, preferably subsequent, step, the location query indicator 20 is preferably compared to a site parameter of the respective securing device 4A to 4K. In the illustrative example, the site parameter is part of the parameter relative to the physical properties 25 or forms the latter. As an alternative or in addition, the latter can also, however, be produced separately or independently. Preferably, a distance between the target location 21 represented by the location query indicator 20 and the respective site of the securing device 4A to 4K is determined by the comparison of the location query indicator 20 to the securing device parameter 22, in particular the parameter relative to the physical properties 25 or the site parameter. Such a determination of time interval is carried out in particular as a geographic distance relative to a linear distance or with consideration of map material with respect to a route, mileage, operating time, travel time, or the like.

Preferably, the system 1 or the central device 3 has a threshold value for the distance, wherein securing devices 4A to 4K that are too far away are discarded and/or those securing devices 4A to 4K with a short distance to the target location 21 are preferred or prioritized.

Preferably, a particular securing device 4A to 4K is selected with the selection module 31 on the basis of one or more of the comparisons or selections. In this case, preferably the securing device 4A to 4K that is physically suitable, available and/or functional and also has a short distance to the target location 21 is selected.

In a quite particular example with regard to FIG. 2, the securing devices 4H and 4I are assigned to target locations 21 in the form of single-family houses. The securing devices 4H and 4I are located physically close to one another, preferably, i.e., in the same physical area, zone, postal code area, or the like. When a pre-selection of securing devices 4A to 4H is made, therefore preferably at least the two securing devices 4H and 4I are preselected.

When the central device 3 receives a reservation signal 9, one or more of the comparisons are preferably carried out, as described previously, by the selection module 31 of the central device 3. In the particular example, the target location 21 identified by the location query indicator is identical to the site of the securing device 4H. When the securing device 4H is not available in the particular case, is not functional and/or has no corresponding authorization for securing the package 2, the securing device 4H is preferably still discarded. When another securing device 4A to 4K, for example the securing device 4I of the adjacent target location 21, is available and functional and has a corresponding authorization, the latter can be selected in particular based on its short distance to the target location 21. Especially preferably, neighbors can thus make their securing device 4A to 4K available for mutual use, in particular by configuration of the parameter relative to an authorization 28. When the particular securing device 4H is then unavailable, the package 2 can be secured by the securing device 4I of the neighbor. This advantageously allows a delivery that is already as close to the target location as possible and an improved loading.

The central device 3 or the selection module 31 is preferably designed to generate, emit and/or to transmit a reservation confirmation signal 38, 39. In the illustrative example according to FIG. 1, the reservation confirmation signal 38, 39 is transmitted via a data connection 32 in particular to a first identification device 33, alternatively also referred to as a receiving device or securing identification device.

The first identification device 33 can be assigned to the reservation device 8 or part of the latter. In the illustrative example, the first identification device 33 is produced independently or structurally separately from the reservation device 8. This has the advantage that, for example in the case of a parcel service, a central office can have or can create the reservation device 8. The first identification device 33 is preferably a terminal device, in particular a mobile terminal device, of an employee who is assigned to make a delivery or pick-up. The first identification device 33 preferably has an interface for the verification device 5A to 5K of the securing device 4A to 4K. In this way, a securing or releasing of the package 2 can be carried out with the selected securing device 4A to 4K.

The reservation confirmation signal 38, 39 preferably has a time confirmation indicator 34 and/or a location confirmation indicator 35 and/or a securing identifier 36 and/or a release identifier 37.

Preferably, the central device 3 is designed to respond to the reservation signal 9 with the reservation confirmation signal 38, 39.

The reservation confirmation signal 38, 39 can be secured by the time confirmation indicator for identifying a date, a time and/or a length of time relative to or over which the package 2 can be secured to the assigned securing device 4A to 4K, and/or can have the location confirmation indicator for identifying a site of the assigned securing device 4A to 4K. Advantageously, by transmitting this information, a site of the assigned securing device 4A to 4K that deviates from the target location 21 and/or a length of time that deviates from the time reservation indicator 16 is indicated. As an alternative or in addition, however, the reservation confirmation signal 38, 39 can also be produced and/or transmitted without the time confirmation indicator 34 and/or without the location confirmation indicator 35, in particular when in this regard, there is no deviation from the target location 21 or of the length of time identified by the time reservation indicator 16.

The reservation confirmation signal 38, 39 preferably has at least one securing identifier 36 and/or releasing identifier 37. Quite especially preferably, a reservation confirmation signal 38, 39 has only either the securing identifier 36 or the releasing identifier 37. The system, in particular the central device 3, can be designed to transmit a first reservation confirmation signal 38 with the securing identifier 36 and a second reservation confirmation signal 39 with the releasing indicator to different identification devices 33, 40, also referred to as receiving devices, or to emit them in some other way to different identification devices 33, 40.

The securing identifier 36 or releasing identifier 37 and/or the securing verification means 14 or releasing verification means 15 is preferably a one-time identification, random sequence, bit sequence, a key or another verification means, which preferably is designed to make possible verification with the securing device 4A to 4K. The verification with the securing identifier 36 and/or the securing verification means 14 can make possible or initiate a securing process, or with the releasing identifier 37 and/or the releasing verification means 15, a releasing with the selected securing device 4A to 4K.

In a particular example, the first reservation confirmation signal 38 is transmitted with the securing identifier 36 to the reservation device 8 or to the first identification device 33 that is assigned to the reservation device 8.

The securing identifier 36 is preferably designed to make possible a verification, and in this way a securing, of the package 2, with the selected securing device 4A to 4K.

In the case of a delivery of a package 2, the parcel service reserves one of the securing devices 4A to 4K, for this purpose preferably sends the reservation signal 9 to the central device 3, and retrieves the securing identifier 36, with which the package 2 can be secured, from the central device 3.

In the case of a shipping of the package 2, the shipper sends the reservation signal 9 to the central device 3 and retrieves the reservation confirmation signal 38, 39 with the securing identifier 36 in order to be able to store the package 2 for a pick-up in the assigned securing device 4A to 4K.

The releasing identifier 37 or the reservation confirmation signal 39 with the releasing identifier 37 is preferably transmitted to a second identification device 40 that is independent of or different from the reservation device 9 and/or the first identification device 33 that is assigned thereto.

Preferably, identification or addressing of the independent second identification device 40 is transmitted by the booking signal 12 to the central device 3. In this case, this can be the location query indicator 20 or another piece of information, preferably a telephone number, e-mail address, or the like.

The independent or different second identification device 40, also referred to as a receiving device or releasing identification device, is preferably a terminal device of a receiver for the package 2. The second identification device 40 is preferably designed to make possible verification by the selected securing device 4A to 4K with the releasing identifier 37. For this purpose, the second identification device 40 can have a display device, in particular a display, an interface, in particular a radio interface, NFC interface, or the like, a printer, or another means for emitting the releasing identifier 37 for verification with the selected securing device 4A to 4K. The same also holds true for the first identification device 33, whereby here, the securing identifier 36 is emitted, displayed, expressed or in some other way thus emitted or transmitted so that a verification with the selected securing device 4A to 4K is made possible.

The releasing identifier 37 is preferably designed to make possible a verification and in this way a releasing of the package 2 with the selected securing device 4A to 4K.

In the case of a delivery of a package 2, a parcel service has stored the package 2 in one of the securing devices 4A to 4K, in particular by means of the securing identifier 36. For receiving, for sampling, or for releasing the package 2, it is preferred that, in particular with the second identification device 40, the releasing identifier 37 is transmitted to the verification device 5A to 5K, by which the package 2 can be released.

In the case that a package 2 is to be shipped by means of the securing device 4A to 4K, a shipper, preferably with the securing identifier 36, has stored a package 2 in the selected securing device 4A to 4K. In this case, the parcel service or the like uses the second identification device 40 or the releasing identifier 37. Preferably, the releasing identifier 37 is transmitted to the verification device 5A to 5K of the selected securing device 4A to 4K, whereupon the selected securing device 4A to 4K makes available the package 2, in particular for shipping.

The reservation device 8 preferably has an input device 41 for entering one or more of the pieces of reservation information 11. In this case, this can be a keyboard 41 and/or a scanner 42 or another input or reading-in device. Other solutions are also possible, however.

According to another also independently achievable aspect of this invention, one or more of the securing devices 4A to 4K has/have a radio interface 43, preferably a standardized WLAN interface. Also, it is preferred that the respective securing device 4A to 4K is designed to be integrated into a radio network by data connection.

FIG. 3 shows the securing device 4K with a radio interface 43, in particular with a WLAN module. The radio interface 43 can preferably be configured in such a way that the data connection 6 can be made possible or built up via a receiver 44, preferably an access point or router.

The data-link connecting of the securing devices 4A to 4K via the radio interface 43 offers the advantage that no additional infrastructure is required for the data connection 6, since, for example, receivers 44 that are already present at the target location 21 can be used. This makes possible an economical, simple, and uncomplicated production of the data connection 6.

The securing devices 4A to 4K are preferably supplied with power over the grid via a power adapter 45. As an alternative or in addition, however, solar cells or other means for power supply can also be used. Also, a rechargeable battery or battery operation is also possible.

The securing devices 4A to 4K, at least, however, those with a radio interface 43, preferably have a configuration interface 46 for configuration of the radio interface 43. In this way, it is possible to enter the respective securing device 4A to 4K in an available radio network, in particular an existing WLAN.

As an alternative or in addition, the radio interface 43 can also produce a connection to form mobile radio networks or the like. The configuration interface 46 preferably has an input device or can be connected thereto. In particular, the configuration interface 46 can have a web interface. The configuration interface 46 is preferably protected from unauthorized access by a password and/or by a switch or a button preferably protected by the securing device. The configuration interface 46 can thus have a switch or button that is preferably protected by the securing device or in some other way in order to build up or to make possible the data connection 6.

It can be provided that the securing devices 4A to 4K have a locking mechanism 47 for a closing device 48 for securing and/or releasing the package 2. Here, however, other solutions are also possible.

The central device 3 is preferably designed to control several securing devices 4A to 4K centrally. The securing devices 4A to 4K and the central device 3 are preferably produced structurally separately from one another. As an alternative or in addition, the securing devices 4A to 4K and the central device 3 are arranged at different sites.

The securing devices 4A to 4K are preferably designed to allow a securing or releasing only after verification of an authorization, in particular an opening of the closing device 48 or flap for storing or removing the package 2.

The system 1 preferably has an in particular at least essentially star-shaped network, wherein the securing devices 4A to 4K in each case are connected in terms of data to the central device 3, but preferably not among one another. This makes it possible to control and/or to manage the securing devices 4A to 4K in a central manner by means of the central device 3.

In a particular example, the system 1 has a number of securing devices 4A to 4K in the form of mail-receiving containers, which are connected in terms of data to the central device 3 and can be controlled by the central device 3. The central device 3 then makes it possible, on the basis of the reservation information, to identify and to select a suitable securing device 4A to 4K. Preferably, the central device 3 generates an assignment between the reservation signal 9 and the securing device 4A to 4K that is to be selected. The securing device 4A to 4K that is to be selected in the form of the mail-receiving container is then controlled by the central device 3 in such a way that the package 2 can be stored in the securing device 4A to 4K that is to be selected.

Advantageously, this invention offers a provider-independent access to the securing devices 4A to 4K.

Preferably, provider-neutral securing devices 4A to 4K are centrally controlled, managed and assigned by the central device 3. This makes it possible to allow several different service providers access to the same securing device 4A to 4K at different, dynamically managed times. Consequently, material expense and costs in connection with several securing devices 4A to 4K for individual providers are avoided.

According to an also independently achievable aspect of this invention, the package parameter 17 corresponds to a storage life, or to a storage temperature range, or to a requirement for refrigeration. The securing device parameter 22 can correspond to a cooling status or a cooling function or a thermal insulation and/or active tempering, in particular cooling, of the securing device 4A to 4K. Preferably, the central device 3 identifies whether the package parameter 17 corresponds to a storage temperature, a storage temperature range and/or a requirement for refrigeration of the package 2 and compares the package parameter 17 to the securing device parameter 22 with respect to a cooling status or a cooling function of the securing device 4A to 4K, preferably only in this case.

Preferably, those securing devices 4A to 4K are selected with which the package 2 can be secured, in particular those securing devices 4A to 4K in which the dimensions of the package 2 that is to be secured are smaller than the maximum dimensions of a package 2 that can be secured by the respective securing device 4A to 4K, which maximum dimensions are suitable for a weight that is greater than the weight of the package 2 and/or which make possible, preferably simultaneously, a maintaining of the temperature range.

According to another also independently achievable aspect of this invention, those securing devices 4A to 4K are selected that fall below a maximum distance that is predetermined or transmitted with the reservation signal 9. With the reservation signal 9, a maximum distance can thus be transmitted to the central device, whereupon preferably those securing devices 4A to 4K are selected, chosen or marked that fall below the maximum distance. As an alternative or in addition, those securing devices 4A to 4K are discarded that exceed a maximum distance that is preset and/or transmitted by means of the reservation signal 9.

In another also independently achievable aspect of this invention, those securing devices 4A to 4K are selected or marked in which the comparison of the package parameter 17 to the securing device parameter 22 and in which in addition the comparison of the authorization identifier 18 to the securing device parameter 22 have led to a selection.

As an alternative or in addition, those securing devices 4A to 4K are selected or marked in which the comparison of the package parameter 17 to the securing device parameter 22 and in addition the comparison of the time query indicator 19 to the securing device parameter 22 have led to a selection of the securing device 4A to 4K.

As an alternative or in addition, those securing devices 4A to 4K are selected in which the comparison of the package parameter 17 to the securing device parameter 22 and the comparison of the location query indicator 20 to the securing device parameter 22 in each case has led to a selection of the securing device 4A to 4K.

As an alternative or in addition, those securing devices 4A to 4K are selected in which the comparison of the authorization identifier 18 to the securing device parameter 22 and the comparison of the time query indicator to the securing device parameter 22 in each case has led to a selection.

As an alternative or in addition, those securing devices 4A to 4K are selected or marked in which the comparison of the authorization identifier 18 to the securing device parameter 22 and the comparison of the location query indicator 20 to the securing device parameter 22 in each case has led to a selection of the securing device 4A to 4K.

As an alternative or in addition, those securing devices 4A to 4K are selected or marked in which the comparison of the time query indicator 19 to the securing device parameter 22 and the comparison of the location query indicator 20 to the securing device parameter 22 in each case has led to a selection of the securing device 4A to 4K.

Especially preferably, those securing devices 4A to 4K are marked and/or selected in which the comparison of the package parameter 17 to the securing device parameter 22, a comparison of the authorization identifier 18 to the securing device parameter 22, and the comparison of the time query indicator 19 to the securing device parameter 22 in each case has led to a selection of the securing device 4A to 4K.

Further especially preferably, those securing devices 4A to 4K are selected and/or marked in which a comparison of the authorization identifier 18 to the securing device parameter 22, a comparison of the time query indicator 19 to the securing device parameter 22, and a comparison of the location query indicator to the securing device parameter 22 in each case has led to a selection of the securing device 4A to 4K.

Further especially preferably, those securing devices 4A to 4K are selected and/or marked in which the comparison of the package parameter 17 to the securing device parameter 22, the comparison of the time query indicator 19 to the securing device parameter 22, and the comparison of the location query indicator 20 to the securing device parameter 22 in each case has led to a selection of the securing device 4A to 4K.

Further especially preferably, those securing devices 4A to 4K are selected and/or marked in which the comparison of the package parameter 17 to the securing device parameter 22, the comparison of the authorization identifier 18 to the securing device parameter 22, and the comparison of the location query indicator 19 to the securing device parameter 22 in each case has led to a selection of the securing device 4A to 4K.

Quite especially preferably, those securing devices 4A to 4K are selected and/or marked in which the comparison of the package parameter 17 to the securing device parameter 22, the comparison of the authorization identifier 18 to the securing device parameter 22, the comparison of the time query indicator 19 to the securing device parameter 22, and/or the comparison of the location query indicator 20 to the securing device parameter 22 in each case has led to a selection of the securing device 4A to 4K.

The selection or marking of the respective securing device 4A to 4K can be carried out by selection of an entry of a securing device database 23 that corresponds to the respective securing device 4A to 4K. As an alternative or in addition, selected and/or marked securing devices 4A to 4K can be put together, for example in a list, a table, a database, a database extract, or the like.

A selection or marking of a securing device 4A to 4K is carried out especially preferably by selection or marking of a securing device identifier that corresponds to the respective securing device 4A to 4K and that clearly corresponds to a specific securing device 4A to 4K. The securing device parameter 22 can have the securing device identifier or vice versa.

According to another also independently achievable aspect of this invention, the securing device 4A to 4K that has the smallest distance determined on the basis of the comparison of the location query indicator 20 to the securing device parameter 22 is selected from among the selected securing devices 4A to 4K. In particular, the securing device 4A to 4K is thus selected that as a result of a comparison of the reservation signal 9 or one or more components of the reservation signal 9 to the securing device parameter 22 is suitable for securing the package 2 and, preferably, has the shortest distance to the target location 21 transmitted to the reservation signal 9 for securing the package 2.

According to another also independently achievable aspect of this invention, it is provided that the central device 3 assigns the selected securing device 4A to 4K to the booking signal 12, wherein the securing device 4A to 4K that is assigned in this way is referred to in particular as an “assigned or selected securing device.” In principle, however, it is also possible that the “assigned or selected securing device” is assigned in another way, assigns another value, or is selected only, especially preferably, in the previously explained way.

According to another also independently achievable aspect of this invention, the central device 3 controls the assigned or selected securing device 4A to 4K, preferably with the booking signal 12.

It is preferred that the central device 3 of the assigned securing device 4A to 4K send the booking signal 12 that has a securing verification means 14 to verify a user who is authorized to secure the package 2 and/or that has a releasing verification means 15 to verify a user who is authorized to release the package 2 and/or that has a time reservation indicator 16 to identify a length of time in which the package 2 is to be secured with the securing device 4A to 4K. In this way, the assigned or selected securing device 4A to 4K can advantageously be controlled in such a way that during the length of time in which the package 2 is to be secured with the assigned securing device 4A to 4K, a user who is authorized to secure the package 2, for example a parcel service employee, can secure the package 2 with the assigned securing device 4A to 4K after verification of his authorization.

As an alternative or in addition, the invention advantageously makes it possible that a user, authorized for releasing the package 2, in particular a recipient, can release the package after verification of his identity or authorization with the releasing verification means 15 and can remove it from the assigned securing device 4A to 4K. At the same time, it is especially preferably prevented that a user who is not authorized to secure the package 2 secures a package 2 with the securing device 4A to 4K.

It is preferred that the respective securing device 4A to 4K or the assigned or selected securing device 4A to 4K be designed to accept a verification by means of the releasing verification means 15 only when a verification by means of the securing verification means 14 was successful prior to this. In this way, it can advantageously be avoided that access to the securing device 4A to 4K is implemented in an incorrect sequence or by an unauthorized entity.

In particular, the respective securing device 4A to 4K is designed, in a time sequence, preferably during the length of time identified by the time query indicator 19 or time reservation indicator 16, to make possible a releasing, only after securing the package 2, especially preferably with the releasing verification means 15, preferably wherein only after securing the package 2 with verification with the securing verification means 14 a releasing of the package 2 is carried out or made possible with verification with the releasing verification means 15, preferably by the securing device 4A to 4K.

According to another preferred aspect of this invention, the securing verification means 14 and the releasing verification means 15 are different from one another.

In a particular example, the assigned or selected securing device 4A to 4K, preferably a mail-receiving container, with a closing device 48, such as a door, flap or the like, and/or a securing container that can be separated from the securing device 4A to 4K, receives the booking signal 12 and is designed by the closing or locking mechanism 47 to open or to make available an interior space only after checking an authorization or after verification. For this purpose, it is especially preferred that a verification can be carried out only relative to the length of time transmitted by means of the time reservation indicator 16 with the securing verification means 14 and/or the securing identifier 36. When the verification by means of the securing verification means 14 and/or the securing identifier 36 is successful within the length of time identified by the time reservation indicator 16, in particular when the securing device 4A to 4K or the assigned or selected securing device 4A to 4K with its verification device 5A to 5K has produced an authorization for securing the package 2 with use of the securing verification means 14 and/or the securing identifier 36, the (assigned) securing device 4A to 4K makes possible a securing of the package 2, in particular, i.e., the opening of the closing device 48, the flap and/or the door.

Until the package 2 is secured, the releasing verification means 15 can be stored and/or deactivated by the assigned or selected securing device 4A to 4K. It is thus preferred that the releasing verification means 15 not be used by the assigned or selected securing device 4A to 4K for verification until a package 2 has been secured by the assigned or selected securing device 4A to 4K or a verification is carried out by means of the securing verification means 14.

The use of the releasing verification means 15 can be activated by the verification by means of the securing verification means 14. It is preferred that after one-time verification by means of the securing verification means 14, another verification by means of the securing verification means 14 be prevented by the assigned or selected securing device 4A to 4K and/or a releasing by means of the releasing verification means 15 is made possible. For releasing by means of the releasing verification means 15, preferably verification is carried out with the verification device 5A to 5K of the assigned securing device 4A to 4K.

According to another aspect of this invention, the securing verification means 14 and/or the releasing verification means 15 can be filed or stored in the securing device 4A to 4K. It thus is not necessary that the releasing verification means 15 be transmitted in each case with the booking signal 12 or independently thereof to the assigned or selected securing device 4A to 4K. When, for example, a securing device 4A to 4K, in particular a mail-receiving container, is assigned to only one specific individual, a specific household or the like, it can be achieved if only one fixed, predetermined releasing verification means 15 is used. This can be provided at the factory or can be set up in the installation.

The securing verification means 14 and/or the releasing verification means 15 are preferably newly or differently generated for each securing or releasing process, preferably by the central device 3. As an alternative or in addition, however, it is also possible that the securing verification means 14 is in particular based on the reservation signal 9 or the information contained therein. In particular, the authorization identifier 18 can be used as a securing verification means 14, or the securing verification means 14 is based on the authorization identifier 18.

The securing identifier 36 is preferably designed with the securing verification means 14 and/or the verification device 5A to 5K of the selected securing device 4A to 4K to make possible verification for securing the package 2. In particular, it is provided that the securing identifier 36 is read in with the verification device 5A to 5K, input, or in some other way is fed to the securing device. The securing verification means 14 and the securing identifier 36 are fed to the selected securing device 4A to 4K preferably in a different way, via different paths, different data connections 6 and/or via different media or data transfer media. As an alternative or in addition, the same applies for the releasing verification means 15 and the releasing identifier 37.

The verification with the securing verification means 14 and the securing identifier 36 can be used in another method, such as for the verification with the releasing verification means 15 and the releasing identifier 37. In particular, it is preferred that the securing verification means 14 and/or the securing identifier 36 be newly generated in the case of each new securing process and the releasing verification means 16 and/or the releasing identifier 37 remain unchanged, or vice versa. In this way, in particular a delivery by different service providers is made possible without the recipient having to regularly update his releasing identifier 37. Conversely, the owner of a securing device 4A to 4K with the consistent securing verification means 14 and/or the securing identifier 36 can secure a package 2 in particular for shipping, while on a case by case basis, the new generation of the releasing identifier 16 and/or the releasing identifier 37 can prevent a pick-up by an unauthorized entity.

The securing device 4A to 4K or the verification device 5A to 5K is preferably designed to compare the securing identifier 36 to the securing verification means 14, to reset them, or in some other way to determine whether the securing identifier 36 corresponds to the securing verification means 14. If the securing identifier 36 corresponds to the securing verification means 14, the securing device 4A to 4K preferably makes possible the securing of the package 2, in particular whereby the securing device 4A to 4K unlocks or opens a flap or door or other closing device 48 for securing the package 2 and/or makes available a securing container that can be separated from the securing device 4A to 4K.

As an alternative or in addition, the reservation confirmation signal 38, 39 has the securing identifier 37. It is preferred that the same reservation confirmation signal 38, 39 has either the securing identifier 36 or the releasing identifier 37, but not both.

It is preferred that the releasing identifier 37 together with the releasing verification means 15 and/or the verification device 5A to 5K make possible a verification of a user who is authorized to release the package 2. In particular, the releasing identifier 37 is read in by the verification device 5A to 5K or input into the latter or fed in some other way to the verification device. The verification device 5A to 5K compares or resets preferably the releasing identifier 37 with the releasing verification means 15. In this way, it is preferably determined whether the releasing identifier 37 corresponds to the releasing verification means 15. When the releasing identifier 37 corresponds to the releasing verification means 15, the assigned or selected securing device 4A to 4K releases the package 2, in particular whereby the securing device 4A to 4K unlocks or opens the closing device 48 and/or makes available a securing container that can be separated from the securing device 4A to 4K. In this way, a sampling is made possible.

The central device 3 preferably generates at least one first reservation confirmation signal 38 with the securing identifier 36 and without the releasing identifier 37. This reservation confirmation signal 38 can be transmitted by the central device 3 to the reservation device 8 or a first identification device 33 that corresponds thereto or a receiving device that corresponds thereto, preferably a mobile receiving device. In this way, it is made possible for a parcel service to secure a mailing by means of the assigned securing device 4A to 4K.

As an alternative or in addition, the central device 3 is designed to generate a second reservation confirmation signal 39 with the releasing identifier 37 and without the securing identifier 36.

It is preferred to send the first and the second reservation confirmation signals 38, 39 to different receiving devices or identification devices 33, 40 that are assigned, preferably according to reservation information 11, to different individuals authorized to secure and/or release.

In a first particular example, the first reservation confirmation signal 38 with the securing identifier 36 is sent to a first identification device 33, for example a parcel service. The parcel service can then secure the package 2 with securing of the securing identifier 36 with the assigned securing device 4A to 4K. In particular, the parcel service provider by means of the securing identifier 36 opens the assigned or selected securing device 4A to 4K in the form of a mail-receiving container and stores the object or the package 2 or parcel in the mail-receiving container.

The second reservation confirmation signal 39 with the releasing identifier 37 is preferably sent to a receiving device or second identification device 40, preferably a receiver, for example to a smartphone, tablet, or the like, preferably after the securing of the package 2 is carried out.

It is preferred that the verification device 5A to 5K according to or by verification with the securing identifier 36 produce a transmission of the releasing identifier 37, preferably by the central device 3 and/or by transmitting a control signal to the central device 3.

After the package 2 with the assigned securing device 4A to 4K has been secured, the receiver with its second identification device 40 or with the releasing identifier 37 can perform a verification with the releasing verification means 15 or the verification device 5A to 5K. The assigned or selected securing device 4A to 4K thereupon releases the package 2, preferably whereby a flap or door of the assigned securing device 4A to 4K in the form of the mail-receiving container is opened and/or the securing container that is held by the securing device 4A to 4K is made available. The package 2, in particular, the parcel, can thereupon be accepted or removed.

In another particular example, a package 2 is to be shipped with a securing device 4A to 4K. For this purpose, the first reservation confirmation signal 38 can be sent out to a shipper or a first identification device 33, and the second reservation confirmation signal 39 can be sent out to a parcel service or a second identification device 40. It is preferred in this variant that the shipper secures the package 2 with use of the securing identifier 36 with in particular the assigned securing device 4A to 4K, and a parcel service employee picks up the package 2 with use of the releasing identifier 37. For this purpose, verification is made by means of the releasing identifier 37.

According to another aspect of this invention, the second reservation confirmation signal 39 is only transmitted, delivered or emitted, especially preferably by the central device 3 and/or the assigned or selected securing device 4A to 4K, when a verification or securing of the package 2 is carried out with the securing identifier 36 and/or the securing verification means 14 and/or the verification device 5A to 5K. In this way, it can be ruled out that a releasing is still not possible since the securing is still not carried out. Especially preferably, the securing device 4A to 4K or assigned or selected securing device 4A to 4K is designed to transmit a confirmation signal to the central device 3 during or after verification with the securing identifier 36 or securing identification means 14 (of the successful verification). The confirmation signal preferably has an identifier of the assigned securing device 4A to 4K. The central device 3 can thereupon transmit the (second) reservation confirmation signal 39 with the releasing identifier 37 or the releasing identifier 37 even independently of the (second) reservation confirmation signal 39.

It is advantageously possible to centrally control and to manage different securing devices 4A to 4K, in particular mail-receiving containers. In this way, it is possible to use the mail-receiving containers independently of providers. For example, it is possible that at a first time or length of time, a first provider occupies a mail-receiving container and at another, second length of time, another provider.

According to another also independently achievable aspect of this invention, one or more of the securing devices 4A to 4K (in each case) has/have a sensor 49 for determining whether a package 2 is secured with the respective securing device 4A to 4K.

The central device 3 is preferably designed to receive a securing device parameter 22 that corresponds to a property of a securing device 4A to 4K and/or to retrieve a securing device parameter 22 from the securing device(s) 4A to 4K and/or to file a securing device parameter 22 in a/the securing device database 23, which corresponds to the sensor signal of the sensor 49 for determining whether a package 2 with the respective securing device 4A to 4K is secured or to a securing state of the respective securing device 4A to 4K. In this way, an unintentional multiple occupancy can advantageously be avoided.

It is preferred that the central device 3 be designed, starting from the respective securing device parameter 22, to prevent a multiple occupancy. In this case, the use of the sensor 49 results in redundancy and the possibility of allowing multiple occupancies even in the case of loss of the data connection 6.

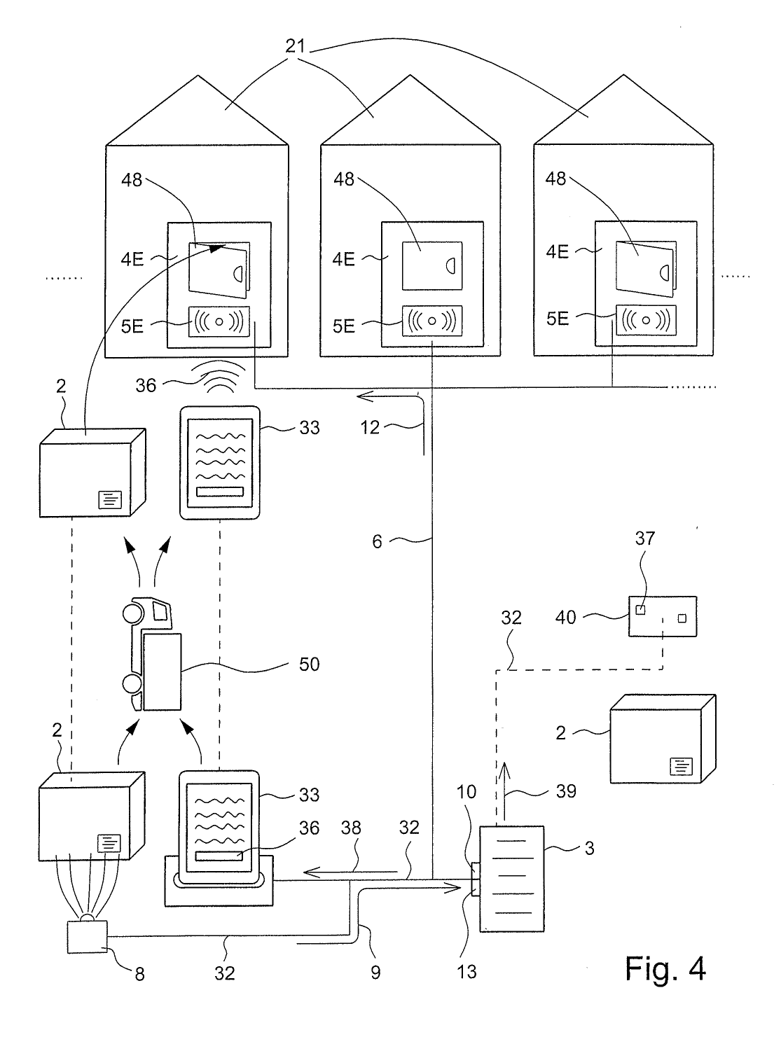

FIGS. 4 & 5 show simplified, diagrammatic views of the system 1 according to the invention in the case of securing and releasing the package 2, based on an especially preferred securing and/or releasing method is explained in more detail below.

A package 2 is preferably detected with the reservation device 8. In particular, the reservation device 8 preferably automatically detects one or more of the package parameters 17. The reservation device 8 also detects or determines and/or reads off from a storage device, or the reservation device 8 preferably calculates the authorization identifier 18 and/or the time query indicator 19 and/or the location query indicator 20.

The reservation device 8 preferably transmits the reservation signal 9, preferably with the package parameter 17 and/or the authorization identifier 18 and/or the time query indicator 19 and/or the location query indicator 20, to the central device 3.

The central device 3 determines—preferably with the reservation signal 9 and/or the package parameter 17 and/or the authorization identifier 18 and/or the time query indicator 19 and/or the location query indicator 20—one of the securing devices 4A to 4K, in the illustrative example according to FIG. 4, one of the securing devices 4E, hereinafter referred to as an assigned or selected securing device 4E, which is suitable for securing the package 2 that corresponds to the reservation signal 9.

The central device 3 preferably transmits the booking signal 12, in particular with the securing verification means 14 and/or the releasing verification means 15 and/or the time reservation indicator 16, to the assigned or selected securing device 4A to 4K.

As an alternative or in addition, the central device 3 transmits the booking signal 12, in particular the securing verification means 14 and/or releasing verification means 15, to the verification device 5A to 5K, in the illustrative example the verification device 5E, of the assigned or selected securing device 4A to 4K.

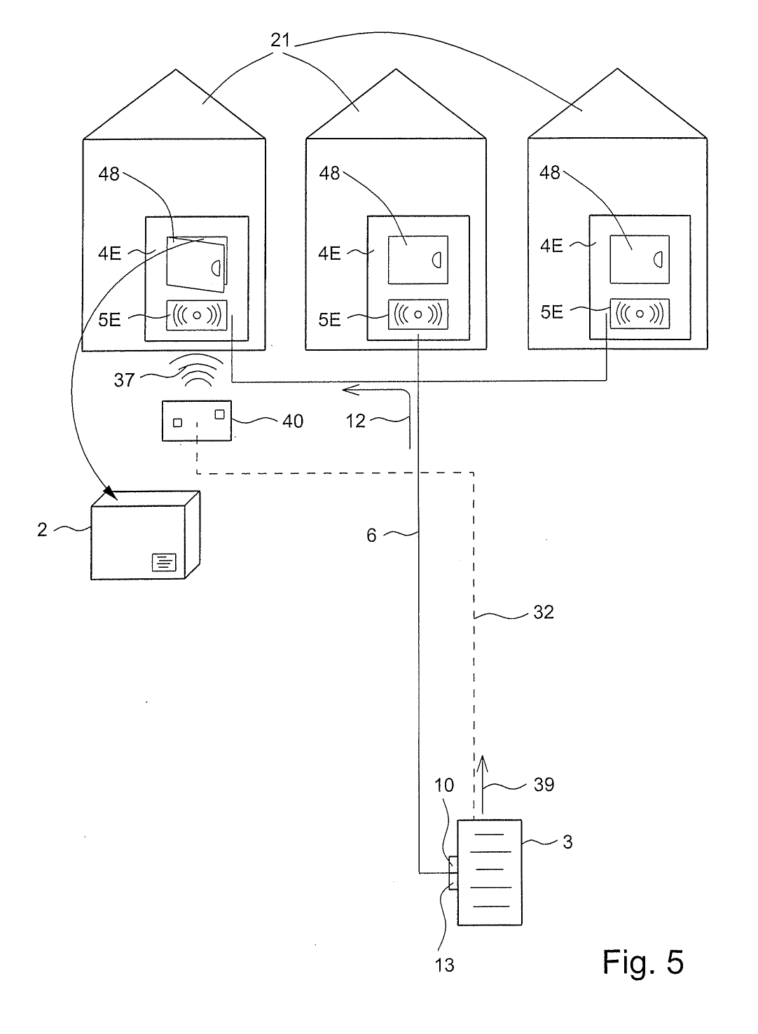

In the illustrative example according to FIGS. 4 and 5, the assigned or selected securing device 4E and/or the verification device 5E of the assigned or selected securing device 4E receives the booking signal 12.

The central device 3 preferably transmits a reservation confirmation signal 38, preferably having the securing identifier 36, to a first identification device 33 which, in the illustrative example, is a smartphone.

The securing identifier 36 is preferably received from the first identification device 33 and/or stored, filed and/or prepared for reading out in the first identification device 33.

The first identification device 33 is preferably portable, battery-operated, rechargeable-battery-operated, passive or in some other way network-independent and/or designed, together with the package 2, parallel with the package 2, to be transported on the package 2 and/or connected to the package 2, as in the illustrative example according to FIG. 4 with a delivery truck 50 of a parcel service.

As an alternative or in addition, the first identification device 33 can also be or have an adhesive label, a tag, an RFID tag, an NFC tag, a barcode or the like, connected or connectable to the package 2.

The first identification device 33 and/or the package 2 is/are preferably transportable or is/are transported to the assigned receiving device 4E.

To secure the package 2, the securing identifier 36 is preferably transmitted to the verification device 5E and/or retrieved from the identification device 33, preferably by the verification device 5E.

The verification device 5E preferably also has the securing verification means 14 that is transmitted in particular from the central device 3 and/or received from the central device 3.

The verification device 5E preferably matches the securing verification means 14 with the securing identifier 36 and determines whether the latter correspond to one another. If the securing identifier 36 for the selected securing device 4E corresponds to the securing verification means 14 of the assigned securing device 4E, and, as an alternative or in addition, the time confirmation indicator 34 corresponds to the current local time of the selected securing device 4E and/or to the time reservation indicator 16, the verification device 5E can control the assigned or selected securing device 4K in such a way that the package 2 can be secured with the assigned or selected securing device 4K.

It is further preferred that the central device 3 transmit a reservation confirmation signal 39, preferably with the releasing identifier 37, to a second identification device 40. As an alternative or in addition, the central device 3 ensures that the releasing verification means 15 that is transmitted to the securing device 4E corresponds to the releasing identifier 37. The releasing identifier 37 is preferably assigned to a second identification device 40. The second identification device 40 is preferably designed to release the package 2. For reasons of clarity, the sampling is explained based on FIG. 5.

For releasing a package 2, it is preferred that with the second identification device 40 present, in particular a card with NFC or RFID functionality, the releasing identifier 37 be transmitted to the verification device 5E of the assigned securing device 4E. As an alternative or in addition, the verification device 5E can retrieve the releasing identifier 37 from the second identification device 40.

The verification device 5E preferably has the releasing verification means 15, which preferably has been transmitted from the central device 3. The verification device 5E preferably matches the releasing verification means 15 with the releasing identifier 37 and releases the package 2 if the releasing verification means 15 corresponds to the releasing identifier 37 or vice versa. In the illustrative example, the releasing is carried out in such a way that the closing device 48 is opened in order to make possible a sampling of the package 2. The releasing can also be carried out in another way, however, preferably controlled by the verification device 5E of the assigned or selected securing device 4E.

It is preferred in principle that the system 1 and/or the central device 3 is/are designed so that the securing verification means 14 always differs from the releasing verification means 15 and/or the securing identifier 36 always differs from the releasing identifier 37.

Especially preferably, the securing identifier 36 and the securing verification means 14 are produced corresponding to one another on a case by case basis. Preferably, the releasing identifier 37 and the releasing verification means 15 are produced corresponding to one another on a case by case basis. It is also possible, however, that the securing identifier 36 is preset and only a corresponding securing verification means 14 is produced or vice versa. The same applies for the generation of the releasing identifier 37 and/or the releasing verification means 15. It is thus also possible that the releasing identifier 37 is preset, and only a corresponding releasing verification means 15 is generated or vice versa.

In another variant, it is provided that the securing identifier 36 and/or the releasing identifier 37 are preset, in particular by the first identification device 33 and/or the second identification device 40, wherein the securing identifier 36 and/or the releasing identifier 37 or a value corresponding thereto, in particular a hash value, is transmitted to the central device 3.

Preferably, the corresponding securing verification means 14 and/or releasing verification means 15 is/are generated relative to the securing identifier 36 and/or the releasing identifier 37 or the value corresponding thereto, in particular the hash value, and/or is/are transmitted to the securing device 4E.

Preferably, the corresponding releasing identifier 37 is generated relative to the securing identifier 36 and/or the securing verification means 14 and/or releasing verification means 15 or the value that corresponds thereto, in particular the hash value, and/or is transmitted to the second identification device 40.

As an alternative or in addition, the first identification device 33 is designed to generate the securing verification means 14 directly and to transmit it to the assigned or selected securing device 4E or the verification device 5E thereof, in particular directly and/or via the central device 3.

As an alternative or in addition, the first identification device 33 is designed to generate the releasing verification means 15 and to transmit it to the assigned or selected securing device 4E or the verification device 5E thereof, in particular directly and/or via the central device 3.

As an alternative or in addition, the first identification device 33 is designed to generate the releasing identifier 37 and to transmit to the second identification device 40, in particular directly or via the central device 3.

As a whole, i.e., in another aspect of this invention, it is preferred that the assignment of one of the securing devices 4A to 4K to a package 2 or to a securing identifier 36 that corresponds to the package 2 be always carried out via or by the central device 3; the means that are necessary for securing and/or releasing, however, can also be generated and/or transmitted separately from the central device 3.

Especially preferably, because of the higher level of security, however, the generation of the securing verification means 14 and/or the releasing verification means 15 and/or the securing identifier 36 and/or the releasing identifier 37 is carried out by the central device 3.

According to another aspect of this invention, the reservation device 8 and the first identification device 33 are produced by the same device. The reservation signal 9 can thus be generated by the first identification device 33.

This makes possible a flexible use of the system 1, if necessary, since a use of the system 1 according to the invention is made possible in the absence of a recipient for the package 2 even on the spot. Several different reservation devices 8 can also be provided.

The reservation device 8 and/or the reservation devices 8 is/are in each case preferably assigned to parcel services, commercial enterprises or logistics firms. The central device 3 is preferably designed to process reservation signals 9 received by the reservation devices 8 according to the first-in first-out principle, sequentially and/or according to priorities, in order to select securing devices 4A to 4K, in particular in such a way that a double booking or a selection of the same securing device 4A to 4K for different packages 2 is prevented.

In a preferred option, the reservation device 8 is equipped with a positional sensor, in particular a GPS receiver, a Galileo receiver, or navigation equipment based on mobile radio cells or the like. The reservation device 8 can determine distinct and/or current positional information of the reservation device 8. This advantageously simplifies the also spontaneous use of the system 1 if necessary.

The current positional information of the reservation device 8 can also be used or transmitted together with a piece of delivery information, such as a delivery address, in particular as a location query indicator 20 or part thereof. The central device 3 can then use several pieces of location information for a selection of the selected securing device 4A to 4K. Preferably, several pieces of location information that are weighted for this purpose are taken into consideration.

The first identification device 33 can also be or form a receiving device for receiving the securing identifier 36. As an alternative or in addition, the second identification device 40 can be or form a receiving device for receiving the releasing identifier 37. It is therefore preferred that the terms “first identification device” and “second identification device” can be replaced by the term “receiving device” or vice versa.

For a locker operation, the first identification device 33 and the second identification device 40 can be produced by the same device. As an alternative or in addition, the system 1 can be designed or set up to accept repeatedly, if necessary, a securing identifier 36 and/or a releasing identifier 37, or a securing identifier 36 and a releasing identifier 37 are identical. In this way, a securing and releasing by the same individual can be made possible.

For the regular operation, it is preferred, however, that the releasing identifier 37 differ from the securing identifier 36 and/or that the releasing verification means 15 differ from the securing verification means 14 and/or that the system 1 be designed in such a way that a releasing identifier 37, a securing identifier 36, a releasing verification means 15 and/or a securing verification means 14 in each case can be used only once or after one-time use is/are cleared, blocked or locked. In this way, who has or has provided access to the securing device 4A to 5K at what time can be clearly reproduced.

A securing device 4A to 4K or a securing container that can be held in the securing device 4A to 4K in terms of this invention is especially preferably an in particular box-like, chest-like or compartment-like container.

The securing device 4A to 4K preferably has an opening for depositing and/or for removing the package 2.

The opening for depositing and/or for removing the package 2 preferably has a clear width, which is greater than 50 cm, preferably greater than 60 cm, in particular greater than 70 cm, and/or less than 150 cm, preferably less than 100 cm, and in particular less than 80 cm.

The opening is preferably designed for securing the package 2 in a closable manner. Especially preferably, the opening of the securing device 4A to 4K can be closed by means of a door or flap or other closing device 48, which can be controlled or unlocked automatically and/or electronically for securing or releasing.

The package 2 can preferably be secured or released with the securing device 4A to 4K in such a way that the opening is made available, a flap or door or another closing device 48 is released, or an access to the package 2 or a securing area for securing the package 2 in some other way is made available.

In particular, the securing device 4A to 4K has a compartment, wherein the package 2 can be secured or released by opening the compartment, depositing the package 2 and subsequently closing the compartment. Here, however, in principle other solutions are also possible.

In an especially preferred embodiment, the securing device 4A to 4K has a door or flap that is spring-loaded in the opening direction in such a way that the door or flap or another closing device 48 opens automatically in the case of an (automatic) unlocking. After depositing or removing the package 2, the door or flap or other closing device 48 can then be closed against the spring force, wherein preferably an (automatic) locking is carried out.

The securing device 4A to 4K can enclose a volume by walls, or it can make the enclosed volume inaccessible in some other way, preferably in such a way that the package 2 can be placed in the volume for securing and can be removed again from the volume for releasing.

The securing device 4A to 4K preferably has a volume that is more than 15 l, preferably more than 20 l, in particular more than 25 l, and/or less than 1,000 l, 500 l, 300 l or 150 l, preferably less than 120 l, in particular less than 100 l.

Individual aspects and features of the invention according to the invention as well as the described method steps and/or variants can be carried out independently of one another, but also in any combination with one another.

1. System for securing objects or packages against unauthorized access, wherein the system comprises several securing devices for securing an object or package and a central device, said central device being able to receive a reservation signal and, on the basis of the reservation signal, to select one of the securing devices, hereinafter referred to as a selected securing device, and to generate at least one of a booking signal or a releasing confirmation signal, wherein the selected securing device can be controlled by verification of at least one of the booking signal and the reservation confirmation signal in such a way that the object or the package can be secured in or released from the selected securing device.

2. System according to claim 1, wherein the booking signal can be transmitted directly from the central device or via a data link to the selected securing device.

3. System according to claim 1, wherein the central device is able to transmit the reservation confirmation signal to one or more of:
At least one reservation device, which is able to transmit the reservation signal to the central device,
an identification device assigned to the reservation device, and
another identification device.

4. System according to claim 3, wherein one or more of the reservation device and the identification device is/are different from the selected securing device or is able to perform verification with the selected securing device.

5. System according to claim 1, wherein the reservation signal comprises one or more of:
a package parameter, which corresponds to physical properties of the object or the package that is to be secured, wherein the central device is able to check the securing devices for suitability for securing the object or package based on the physical properties thereof, and depending on the suitability to select one or more of the securing devices,
has an authorization identifier for identifying an authorization for use of one or more of the securing devices, and the central device is able to select one or more of the securing devices identified by the authorization identifier,
a time query indicator for identifying at least one of a time, a date, and a length of time, relative to which the object or package, is to be secured with one of the securing devices, wherein the central device is able to compare the at least one on of the time identified by the time query indicator, the date identified by the time query indicator, and the length of time identified by the time query indicator with an availability of the securing devices, and based on the result of the comparison to select one or more securing devices, and
a location query indicator for identifying a target location for securing the object or package, wherein the central device is able to determine distances in each case between the target location and the respective site of the securing devices and to select one or more of the securing devices on the basis of a comparison of the distances.

6. System according to claim 1, wherein the booking signal has one or more of:
a securing verification means for verification of a user who is authorized to secure the object or package, wherein the respective securing device is able to make possible a securing of the object or package, only after verification with the securing verification means,
a releasing verification means for verification of a user who is authorized to release the object or package, wherein the respective securing device is able to make possible a releasing of the object or package, only after verification with the releasing verification means and prior verification with the securing verification means, and
a time reservation indicator for identifying a length of time in which the object or the package is to be secured with the securing system, wherein the respective securing device is able to make possible a securing or releasing of the object or package only in the length of time identified by the time reservation indicator.

7. System according to claim 1, wherein the reservation confirmation signal has one or more of:
a time confirmation indicator for identifying one or more of a date, a time, and a length of time, relative to or via which the object or the package is to be secured with the assigned securing system,
a location confirmation indicator for identifying a site of the assigned securing system for securing the object or package,
a securing identifier for identifying a user who is authorized to secure the object or package, wherein the respective securing device is able to make possible a securing of the object or package, only after verification with the securing identifier, and
a releasing identifier for identifying a user who is authorized to release the object or package, wherein the respective securing device is able to make possible a releasing of the object or package, only after verification with the releasing identifier.

8. System according to claim 7, wherein the central device is able to generate a first reservation confirmation signal with the securing identifier and without the releasing identifier and a second reservation confirmation signal, different from the first, with the releasing identifier and without the securing identifier or to send them to identification devices that are different or independent from one another.

9. System according to claim 1, wherein the central device has a securing device database, in which relative to the securing devices, in each case one or more securing device parameters corresponding to respectively one or more of a property of the respective securing device, to one or more properties relative to a site, to a capacity, to an occupancy, to an authorization for use, and to a tempering property of the respective securing device or for the respective securing device.

10. System according to claim 9, wherein the central device relative to one or more is able to: receive securing device parameters, retrieve securing device parameters, and file securing device parameters in the securing device database,
wherein the securing device parameter corresponds to at least one of: a property of a securing device, a sensor signal of a sensor for determining whether a package is secured with the respective securing device, and regarding an error state/or tempering property of the respective securing device.

11. System according to claim 5, wherein the central device is to compare the package parameter to the one or more securing device parameters or the physical properties of the object or package represented by the package parameters with the capacity of the securing device represented by the securing device parameters.

12. System according to claim 5, wherein the central device is able to compare the authorization identifier to the one or more securing device parameters or the authorization of the respective securing device represented by the securing device parameters for use of the respective securing device with an authorization, identified by the authorization identifier, for use of the respective securing device.

13. System according to claim 5, wherein the central device is able to compare the time query indicator to the securing device parameter, or the availability of the respective securing device, represented by the securing device parameter, to the one or more of the time identified by the time query indicator, the date identified by the time query indicator, and the length of time identified by the time query indicator.

14. System according to claim 5, wherein the central device is able to compare the location query indicator to the securing device parameter, or whereby a distance between the target location identified by the location query indicator and the respective site of the securing devices is determined.

15. System according to claim 11, wherein the central device is able to select the securing device that is physically suitable for securing according to the result of the comparison of the package parameter to the securing device parameter.

16. System according to claim 12, wherein the central device is able to select the securing device that is entitled to authorize securing according to the result of the comparison of the authorization identifier to the securing device parameter.

17. System according to claim 13, wherein the central device is able to select the securing device that is available according to the result of the comparison of the time query indicator to the securing device parameter.

18. System according to claim 14, wherein the central device is able to select the securing device that has the smallest distance from the target location according to the result of the comparison of the location query indicator to the securing device parameter.

19. Method for securing objects or packages against unauthorized access with several securing devices for securing the object or package and with a central device that is able to receive a reservation signal, wherein on the basis of the reservation signal, one of the securing devices is selected, hereinafter referred to as a selected securing device, and wherein at least one of a booking signal and a reservation confirmation signal is generated by the central device, and wherein the selected securing device is secured or released by verification with the at least one of the booking signal and the reservation confirmation signal of the object or the package with the selected securing device.

20. Central device for a system for securing objects or packages against unauthorized access, wherein the central device has a user interface with data connections to several securing devices for securing an object or package, and wherein the central device is able to receive a reservation signal and on the basis of the reservation signal to select one of the securing devices, hereinafter referred to as a selected securing device, and wherein the central device is designed to generate one or more of a booking signal and a reservation confirmation signal, wherein one or more of the booking signal and the reservation confirmation signal are able to ensure that the object or the package can be secured or released upon verification with one or more of the booking signal and the reservation signal with the selected securing device.
